(19) United States
(12) Patent Application Publication
(10) Pub. No.: US 2026/0045705 A1
(43) Pub. Date: Feb. 12, 2026

(54) CROSS-DIPOLE RADIATING ELEMENTS HAVING FEED STALKS THAT EXHIBIT IMPROVED CLOAKING PERFORMANCE AND BASE STATION ANTENNAS INCLUDING SUCH RADIATING ELEMENTS

(71) Applicant: Outdoor Wireless Networks LLC, Claremont, NC (US)

(72) Inventors: Haifeng LI, Allen, TX (US); Peter J. BISIULES, LaGrange Park, IL (US)

(21) Appl. No.: 19/100,066

(22) PCT Filed: Oct. 3, 2023
(86) PCT No.: PCT/US2023/075771

§ 371 Date: Jan. 30, 2025

Related U.S. Application Data
(60) Provisional application No. 63/414,127, filed on Oct. 7, 2022.

(51) Int. Cl. H01Q 21/26; H01Q 1/24; H01Q 21/06

(52) U.S. Cl. CPC H01Q 21/26; H01Q 1/246; H01Q 21/062

(57) ABSTRACT

A cross-dipole radiating element includes a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line, a first signal trace that at least partially overlaps the first ground line, and a transmission line segment that extends from the first ground line and/or the first signal trace, and the transmission line segment includes a transmission line signal trace that is short-circuited to a ground conductor of the transmission line segment.

### CROSS-REFERENCE TO RELATED APPLICATION

The present application claims priority to U.S. Provisional Patent Application Ser. No. 63/414,127, filed Oct. 7, 2022, the entire content of which is incorporated herein by reference.

### BACKGROUND

The present invention generally relates to radio communications and, more particularly, to base station antennas for cellular communications systems and to radiating elements for such base station antennas.

Cellular communications systems are well known in the art. In a cellular communications system, a geographic area is divided into a series of regions that are referred to as “cells” which are served by respective base stations. The base station may include one or more base station antennas that are configured to provide two-way radio frequency (“RF”) communications with mobile subscribers that are within the cell served by the base station. Typically, the base station antennas are mounted on a tower or other raised structure, with the radiation patterns (also referred to herein as “antenna beams”) that are generated by the base station antennas directed outwardly. In many cases, each cell is divided into a plurality of smaller regions in the horizontal or “azimuth” plane that are called “sectors.” In one common configuration, a hexagonally shaped cell is divided into three 120° sectors in the azimuth plane, and each sector is served by one or more “sector” base station antennas that generate antenna beams having azimuth Half Power Beamwidths (“HPBW”) of approximately 65°, which provides good coverage throughout the 120° sector. The antenna beams are generated by linear or planar phased arrays of radiating elements that are included in the antenna. The radiating elements are typically mounted to extend forwardly from a flat metal surface called a reflector that acts as a ground plane for the radiating elements and that acts to reflect rearwardly directed RF radiation emitted by the radiating elements back in the forward direction.

In order to accommodate the increasing volume of cellular communications, cellular operators have added cellular service in a variety of new frequency bands. While in some cases it is possible to use a single array of “wide-band” radiating elements to provide service in multiple frequency bands, in other cases it is necessary to use different arrays of radiating elements to support service in the different frequency bands. As a result, the number of base station antennas deployed at a typical base station has increased significantly. However, due to local zoning ordinances and/or weight and wind loading constraints for the antenna towers, there is often a limit as to the number of base station antennas that can be deployed at a given base station. In order to increase capacity without further increasing the number of base station antennas, so-called multi-band base station antennas have been introduced which include multiple arrays of radiating elements that operate in different frequency bands. Unfortunately, the radiating elements in the different arrays can interact with each other, which may make it challenging to implement such a multi-band antenna while also meeting customer requirements relating to the size (and particularly the width) of the base station antenna.

### SUMMARY

Pursuant to embodiments of the present invention, cross-dipole radiating elements are provided that include a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line, a first signal trace that at least partially overlaps the first ground line, and a transmission line segment that extends from the first ground line and/or the first signal trace. The transmission line segment includes a transmission line signal trace that is short-circuited to a ground conductor of the transmission line segment.

In some embodiments, the transmission line segment is at least a portion of a short-circuited transmission line that is configured to suppress unbalanced currents from flowing onto the feed stalk.

In some embodiments, the transmission line segment is at least a portion of a short-circuited transmission line that has a base adjacent a distal end of the feed stalk, where the transmission line signal trace short-circuited to the ground conductor of the transmission line segment about a quarter wavelength of a center frequency of an operating frequency band of the cross-dipole radiating element away from the base of the short-circuited transmission line.

In some embodiments, the transmission line signal trace extends from the first signal trace.

In some embodiments, the ground conductor of the transmission line segment extends from the first ground line.

In some embodiments, the first ground line acts as the ground conductor of the transmission line segment.

In some embodiments, the feed stalk comprises a feed stalk printed circuit board, and the first signal trace is a first metallization pattern on a first side of the feed stalk printed circuit board and the first ground line is a second metallization pattern on a second side of the feed stalk printed circuit board. In some embodiments, the feed stalk further comprises a second ground line that comprises a third metallization pattern on the second side of the feed stalk printed circuit board that is separated from the first ground line by a gap, and wherein the first signal trace and the transmission line signal trace each overlap the gap. In some embodiments, a first end of the transmission line signal trace is connected to the first ground line via a first plated through hole in the feed stalk printed circuit board and the second end of the transmission line signal trace is connected to the second ground line via a second plated through hole in the feed stalk printed circuit board. In some embodiments, a distal end of the first signal trace extends forwardly.

In some embodiments, a width of the transmission line signal trace is less than a width of the first signal trace.

In some embodiments, the transmission line signal trace includes at least one meandered section.

In some embodiments, the ground conductor of the transmission line segment has an average width that is less than an average width of the first ground line and the transmission line signal trace has an average width that is less than an average width of the first signal trace.

In some embodiments, the first signal trace directly feeds the first dipole arm and the first ground line directly feeds the second dipole arm.

In some embodiments, a base of the transmission line segment is connected to the first ground line and/or the first signal trace, and the transmission line segment is short-circuited to the ground conductor of the transmission line segment at a distal end of the transmission line segment.

In some embodiments, the cross-dipole radiating element is provided in combination with a base station antenna that includes a second radiating element that is configured to operate in a second frequency band that is higher than an operating frequency band of the cross-dipole radiating element. An open ended line that is configured to act as a bandpass filter that suppresses currents in the second frequency band may extend from the first ground line. Additionally or alternatively, a central region of the first ground line may include an open area where metallization is omitted that is configured to operate as a high-pass filter that suppresses currents in the second frequency band. Additionally or alternatively, a forward portion of the first ground line may include a plurality of slots where metallization is omitted that are configured to suppress currents in the second frequency band.

Pursuant to further embodiments of the present invention, cross-dipole radiating elements are provided that include a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line that extends from the base to connect to the first dipole arm, a first signal trace that extends from the base to connect to the second dipole arm and a transmission line segment that has a transmission line signal trace that extends from the first signal trace.

In some embodiments, the transmission line signal trace is short-circuited to the first ground line.

In some embodiments, the transmission line segment is a first transmission line segment and portions of the first signal trace and the first ground line that extend from the first transmission line segment to the first dipole arm form a second transmission line segment, the first transmission line segment and the second transmission line segment forming a short-circuited transmission line.

In some embodiments, a distal end of the transmission line signal trace is short-circuited to the first ground line so that the first transmission line segment and the second transmission line segment form a short-circuited transmission line. In some embodiments, an electrical length of the short-circuited transmission line is between 0.2 and 0.35 of a wavelength that corresponds to a center frequency of an operating frequency band of the cross-dipole radiating element. In some embodiments, the short-circuited transmission line is configured to block unbalanced currents from flowing onto the feed stalk.

In some embodiments, the first ground line forms a ground conductor of the transmission line segment.

In some embodiments, the feed stalk comprises a feed stalk printed circuit board, and the first signal trace is a metallization pattern on a first side of the feed stalk printed circuit board and the first ground line is a second metallization pattern on a second side of the feed stalk printed circuit board. In some embodiments, the transmission line signal trace is a third metallization pattern on the first side of the feed stalk printed circuit board. In some embodiments, a first end of the transmission line signal trace is connected to the first ground line via a first plated through hole in the feed stalk printed circuit board.

In some embodiments, a width of the transmission line signal trace is less than a width of the first signal trace. In some embodiments, the transmission line signal trace includes at least one meandered section.

In some embodiments, a base of the transmission line segment is connected to the first ground line and/or the first signal trace, and the transmission line segment is short-circuited to the ground conductor of the transmission line segment at a distal end of the transmission line segment.

The cross-dipole radiating element may be provided in combination with a base station antenna that includes a second radiating element that is configured to operate in a second frequency band that is higher than an operating frequency band of the cross-dipole radiating element. In some embodiments, an open ended line that is configured to act as a bandpass filter that suppresses currents in the second frequency band extends from the first ground line. In some embodiments, a central region of the first ground line includes an open area where metallization is omitted that is configured to operate as a high-pass filter that suppresses currents in the second frequency band. In some embodiments, a forward portion of the first ground line includes a plurality of slots where metallization is omitted that are configured to suppress currents in the second frequency band.

Pursuant to other embodiments of the present invention, cross-dipole radiating elements are provided that include a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line that extends from the base to connect to the first dipole arm, a second ground line that is separated from the first ground trace by a gap, a first signal trace that crosses the gap, and a transmission line segment that includes a transmission line signal trace that crosses the gap.

In some embodiments, the second ground line connects to the second dipole arm.

In some embodiments, the first signal trace is short-circuited to the first ground line on a first side of the gap and is short-circuited to the second ground line on a second side of the gap.

In some embodiments, the transmission line segment is at least a portion of a short-circuited transmission line that is configured to suppress unbalanced currents from flowing onto the feed stalk.

In some embodiments, the transmission line segment is at least a portion of a short-circuited transmission line that has a base adjacent a distal end of the feed stalk, where the transmission line signal trace short-circuited to the ground conductor of the transmission line segment about a quarter wavelength of a center frequency of an operating frequency band of the cross-dipole radiating element away from the base of the short-circuited transmission line.

In some embodiments, the first ground line acts as the ground conductor of the transmission line segment.

In some embodiments, a distal end of the first signal trace extends forwardly.

Pursuant to additional embodiments of the present invention, cross-dipole radiating elements are provided that include a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line and a first stub that extends from the first ground line that has a distal end that is open-circuited.

The cross-dipole radiating element may be provided in combination with a base station antenna that includes a second radiating element that is configured to operate in a second frequency band that is higher than an operating frequency band of the cross-dipole radiating element. In some embodiments, the first stub is configured to act as a bandpass filter that suppresses currents in the second frequency band extends from the first ground line. In some embodiments, the feed stalk further comprises a second ground line and a second stub that extends from the second ground line that has a distal end that is open-circuited, the second stub configured to act as a bandpass filter that suppresses currents in the second frequency band. In some embodiments, the first ground line and the second ground line each extend from the base of the feed stalk to the distal end of the feed stalk. In some embodiments, the feed stalk further comprises a third stub that extends from the first ground line that has a distal end that is open-circuited, the third stub configured to act as a bandpass filter that suppresses currents in the second frequency band, and a fourth stub that extends from the second ground line that has a distal end that is open-circuited, the fourth stub configured to act as a bandpass filter that suppresses currents in the second frequency band.

Pursuant to still further embodiments of the present invention, base station antennas are provided that include a first radiating element that is configured to operate in a first frequency band and a second radiating element that is configured to operate in a second frequency band that is lower than the first frequency band. The second radiating element comprises a feed stalk and at least one radiator mounted at a distal end of the feed stalk, the feed stalk including a first ground line that extends substantially from the base of the feed stalk to the distal end of the feed stalk, the first ground line including an interior opening that is completely enclosed by the first ground line, the interior opening forming a high pass filter that suppresses RF current in the first frequency band.

In some embodiments, the feed stalk further comprises a second ground line and a signal trace, wherein at least a rearward potion of the signal trace overlaps the second ground line.

In some embodiments, the interior opening is located in a rearward portion of the first ground line.

In some embodiments, the interior opening is a rectangular opening.

Pursuant to still yet additional embodiments of the present invention, base station antennas are provided that include a first radiating element that is configured to operate in a first frequency band and a second radiating element that is configured to operate in a second frequency band that is lower than the first frequency band, the second radiating element comprising a feed stalk and at least one radiator mounted at a distal end of the feed stalk, the feed stalk including a first ground line that extends substantially from the base of the feed stalk to the distal end of the feed stalk, the first ground line including a plurality of slots formed therein that form a high pass filter that suppresses RF current in the first frequency band.

In some embodiments, the feed stalk further comprises a second ground line and a signal trace, wherein at least a rearward potion of the signal trace overlaps the second ground line.

In some embodiments, the second ground line includes a plurality of slots formed therein that form a high pass filter that suppresses RF current in the first frequency band.

In some embodiments, the plurality of slots are formed in a portion of the first ground line that is forward of the signal trace.

In some embodiments, a first of the plurality of slots extends inwardly from a first side of the first ground line and a second of the plurality of slots extends inwardly from a second side of the first ground line that is opposite the first side.

### BRIEF DESCRIPTION OF THE DRAWINGS

FIG. 1A is a perspective view of a conventional cross-dipole radiating element.

FIG. 1B is a side view of the conventional cross-dipole radiating element of FIG. 1A.

FIG. 2A is a schematic perspective view of a base station antenna according to embodiments of the present invention.

FIG. 2B is a schematic front view of an antenna assembly of the base station antenna of FIG. 2A.

FIG. 2C is a schematic cross-sectional view of the antenna assembly of FIG. 2B with the components mounted behind the reflector of the antenna assembly omitted.

FIGS. 3-5 are schematic side views of cross-dipole radiating elements according to certain embodiments of the present invention.

FIGS. 6A-6F are schematic shadow views of modified versions of the feed stalk printed circuit board of FIG. 4 illustrating how the short-circuited transmission lines according to embodiments of the present invention may have different lengths.

FIGS. 7A-7D are schematic shadow views of the first and second major surfaces of modified versions of the feed stalk of FIG. 4 illustrating different connection schemes for connecting to the dipole arms of the dipole radiators that are fed by the feed stalk.

FIG. 8 is a schematic shadow view of a cross-dipole radiating element according to further embodiments of the present invention.

FIGS. 9A-9D are schematic shadow views of feed stalk printed circuit boards according to further embodiments of the present invention that include filter structures that suppress higher frequency band currents.

### DETAILED DESCRIPTION

As discussed above, it can be challenging to provide relatively narrow base station antennas that have arrays of radiating elements that operate in several different frequency bands. The width of a multi-band base station antenna may be reduced by decreasing the separation between adjacent arrays of radiating elements. However, as the separation between arrays is reduced, increased coupling between the radiating elements of the different arrays occurs, which results in “scattering” of the RF signals at one frequency band by the radiating elements of other frequency bands. Scattering is undesirable as it may affect the shape of the antenna beam in both the azimuth and elevation planes, and the effects may vary significantly with frequency, which may make it hard to compensate for these effects. For example, scattering tends to negatively impact the beamwidth, beam shape, pointing angle, gain and front-to-back ratio of the antenna beams in the azimuth plane.

Scattering primarily occurs when a conductive structure of a first frequency band radiating element has an electrical length that makes the structure resonant in the operating frequency band of a nearby radiating element that operates in a different second frequency band. For example, most modern base station antennas include both “low-band” radiating elements that operate in the 696-960 MHz frequency band or a portion thereof and “mid-band” radiating elements that operate in the 1427-2690 MHz frequency band (or the 1695-2690 MHz frequency band) or a portion thereof. If cross-dipole radiating elements are used, the low-band dipole radiators typically have a length that is approximately ½ a wavelength of the center frequency of the low-band operating frequency band or a portion thereof (e.g., the dipole radiators will have an electrical length that that is approximately ½ a wavelength of the 828 MHz center frequency of the 696-960 MHz operating frequency band). Herein, the wavelength corresponding to the center frequency of the operating frequency band of a radiating element is referred to as the “center wavelength.” In this situation, the electrical length of a low-band dipole arm (which is half the length of the low-band dipole radiator) will be approximately ½ a wavelength of RF signals transmitted in the lower portion of the mid-band operating frequency band, and hence RF energy transmitted by the mid-band radiating elements (particularly when the mid-band radiating elements operate in the lower portion of the mid-band operating frequency band) will tend to couple to the dipole arms of the low-band radiating elements. As described above, this coupling can distort the antenna patterns generated by an array of mid-band radiating elements in undesirable ways. Similar distortion can occur if RF energy emitted by so-called high-band radiating elements (which typically operate in a portion of the 3.1-5.8 GHz frequency band) couples to the low-band radiating elements or to the mid-band radiating elements. The radiating elements according to embodiments of the present invention may be designed to be substantially transparent to nearby radiating elements that operate in other frequency bands so that scattering is largely eliminated. Radiating elements that are designed to suppress such scattering are commonly referred to as “cloaking” radiating elements.

Cloaking radiating elements are known in the art. For example, U.S. Pat. No. 9,570,804 discloses a low-band radiating element that includes dipole arms that are formed as a series of RF chokes. The RF chokes suppress the formation of mid-band current on the low-band dipole arms in order to render the low-band radiating element substantially transparent to mid-band RF energy. U.S. Pat. Nos. 10,439,285 and 10,770,803 each disclose low-band radiating elements that include dipole arms that are formed as a series of widened segments that are coupled by narrow inductive segments, which may be implemented as small, meandered trace segments on a printed circuit board. In each case, the narrow inductive segments act as high impedance elements for RF energy in the mid-band frequency range, rendering the low-band radiating elements substantially transparent to RF energy in that frequency range. As another example, U.S. Pat. No. 11,018,437 discloses a low-band radiating element that includes two dipole arms that are substantially transparent to mid-band RF energy and another two dipole arms that are substantially transparent to high-band RF energy. Additional cloaking radiating element designs are disclosed in Chinese Patent No. CN 112787061A, Chinese Patent No. CN 112164869A, Chinese Patent No. CN 112290199A, Chinese Patent No. CN 111555030A, Chinese Patent No. CN 112186333A, Chinese Patent No. CN 112186341A, Chinese Patent No. CN 112768895A, Chinese Patent No. CN 112821044A, Chinese Patent No. CN 213304351U, Chinese Patent No. CN 112421219A, and PCT Publication WO 2021/042862.

The above-described cloaking radiating elements focus on ensuring that the RF energy emitted by a higher-band radiating element does not form higher-band currents on the dipole arms of a nearby low-band radiating element. The present invention is based, in part, on the realization that the feed stalks of the lower-band radiating elements may also cause scattering. A feed stalk of a cross-dipole radiating element refers to a structure that feeds RF signals to and from the dipole arms of the radiating element. In most case, the dipole arms are mounted on the distal (forward) end of the feed stalk, and the base (rear) end of the feed stalk is mounted on the reflector of the base station antenna or on a feed board printed circuit board that is mounted on the reflector.

The feed stalk of a radiating element typically has a length that is about ¼ of the center wavelength so that RF radiation that is emitted rearwardly by the dipole radiators will reflect off of the reflector and be in-phase with the RF radiation emitted in the forward direction by the dipole arms (since the phase of the RF radiation will change by 90° as it travels a ¼ of the center wavelength from the dipole arm to the reflector, will change by another 180° as it reflects off of the reflector, and will change by an additional 90° as it travels a ¼ of the center wavelength back to the dipole radiator). The feed stalks typically include metal structures that extend along the length of the feed stalk, and hence these metal structures may have a length that is about ¼ of the center wavelength of the radiating element. As such, these metal structures may be about ½ the wavelength of RF signals that are emitted by nearby mid-band radiating elements. As a result, mid-band currents may form on these metal structures that generate mid-band RF radiation. While the emission of mid-band RF radiation from the feed stalks tends to be much lower than the emission of mid-band RF radiation from non-cloaked dipole arms, the emission levels are still significant enough to distort the mid-band antenna beams.

Pursuant to embodiments of the present invention, cross-dipole radiating elements are provided that have feed stalks that exhibit improved cloaking performance. These radiating elements may be included in multi-band base station antennas, and may potentially allow the arrays in such antennas to be spaced more closely together, thereby advantageously reducing the width of the antenna. Base station antennas that include the radiating elements according to embodiments of the present invention may be used, for example, as sector antennas in the above-described cellular communications systems.

Before discussing the radiating elements according to embodiments of the present invention it is helpful to discuss the design and operation of a representative conventional low-band radiating element for a base station antenna.

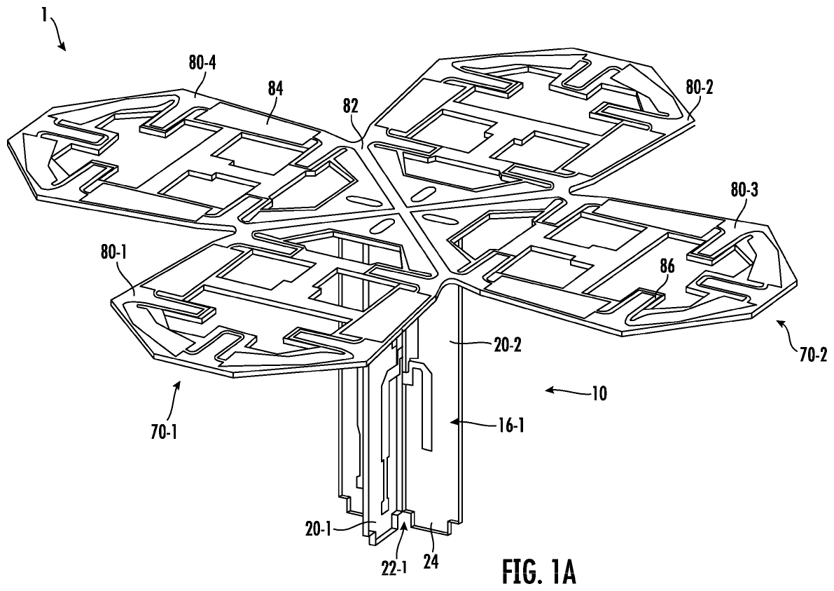

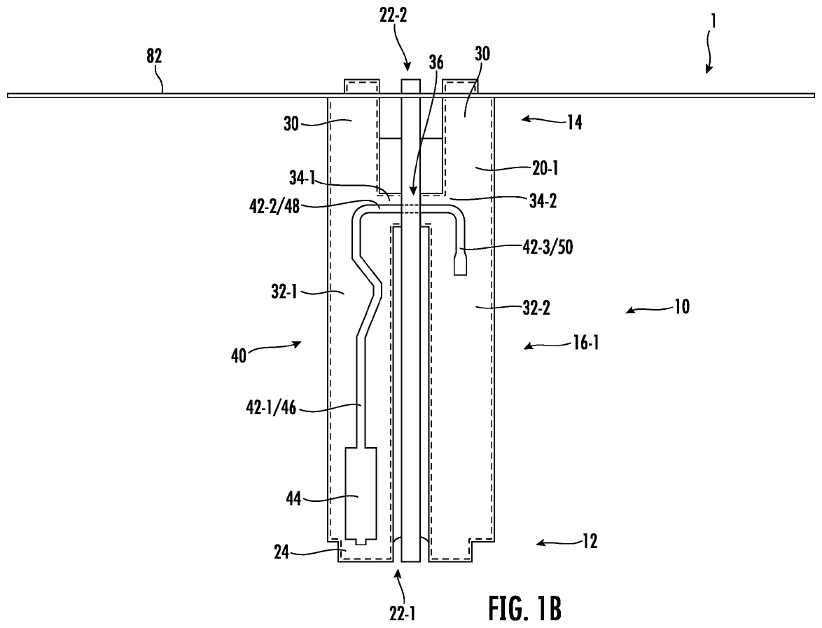

FIG. 1A is a perspective view of a conventional low-band cross-dipole radiating element 1. As shown in FIG. 1A, the conventional cross-dipole radiating element 1 includes a feed stalk 10 and a pair of dipole radiators 70-1, 70-2. It should be noted that herein like elements may be referred to individually by their full reference numeral (e.g., dipole radiator 70-2) and may be referred to collectively by the first part of their reference numeral (e.g., the dipole radiators 70). The feed stalk 10 comprises first and second feed stalk printed circuit boards 20-1, 20-2. Each feed stalk printed circuit board 20-1, 20-2 includes a respective RF transmission line structure 16-1, 16-2 that carry RF signals between first and second feed transmission lines (not shown) for the radiating element 1 and the respective cross-dipole radiators 70-1, 70-2. Each feed transmission line (not shown) may comprise, for example, a microstrip transmission line on a feed board printed circuit board that the radiating element 1 is mounted on or a coaxial cable. The feed transmission lines carry RF signals between the radiating element 1 and other components of the base station antenna. The feed stalk 10 may extend rearwardly from a plane defined by the dipole radiators 70-1, 70-2. For example, the feed stalk 10 may extend generally perpendicular to plane defined by the dipole radiators 70-1, 70-2.

The feed stalk 10 has a base 12 and a distal end 14 (see FIG. 1B). The distal end 14 is positioned forwardly of the base 12. The first feed stalk printed circuit board 20-1 includes a slit 22-1 that extends rearwardly from the distal end 14 of the feed stalk 10, and the second feed stalk printed circuit board 20-2 includes a slit 22-2 that extends forwardly from the base 12 of the feed stalk 10. Feed stalk printed circuit boards 20-1 and 20-2 are arranged perpendicular to each other with the slit 22-2 in feed stalk printed circuit board 20-2 received within the slit 22-1 in feed stalk printed circuit board 20-1 so that the two mated feed stalk printed circuit boards 20-1, 20-2 have a cross-shape when viewed from the front.

Rear portions of each feed stalk printed circuit board 20 may include projections 24 that are inserted through slits in a feed board printed circuit board (not shown). Metallized pads on the projections 24 may be soldered to metallized pads on the feed board printed circuit board to mechanically mount the radiating element 1 on the feed board printed circuit board and to electrically connect the RF transmission line structures 16-1, 16-2 on the feed stalk 10 to the feed transmission lines on the feed board printed circuit board.

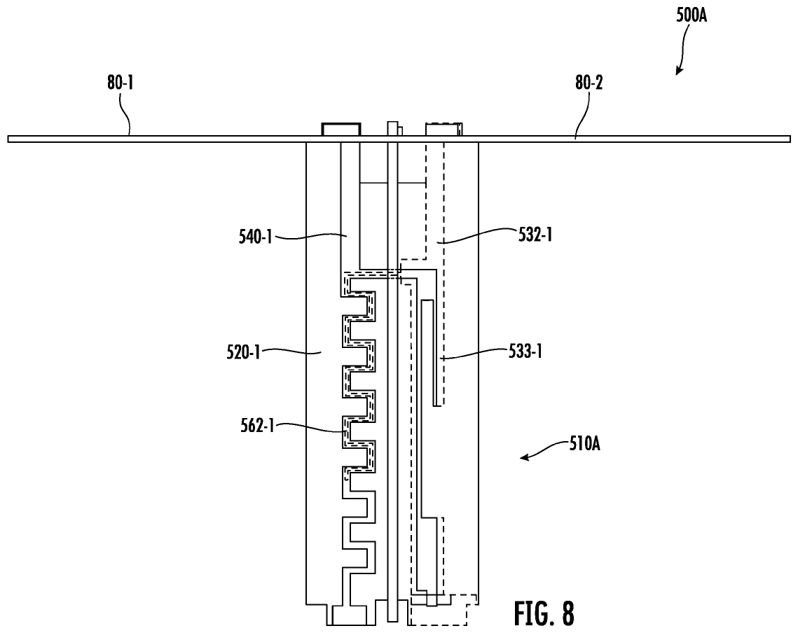

The dipole radiators 70-1, 70-2 are positioned adjacent the distal end 14 of the feed stalk 10 and may be (and typically are) physically mounted on the distal end 14 of the feed stalk 10. The first dipole radiator 70-1 includes first and second dipole arms 80-1, 80-2, and the second dipole radiator 70-2 includes third and fourth dipole arms 80-3, 80-4. As shown in FIG. 1A, the dipole radiators 70-1, 70-2 may be implemented in a “cross” arrangement to form a pair of center-fed −45°/+45° dipole radiators 70. The dipole radiators 70-1, 70-2 are shown as having an elongated “figure 8” shape where each dipole arm 80 is formed as a loop. It will be appreciated that a wide variety of dipole arms are known in the art, including dipole arms having loop shapes, bar shapes, leaf shapes, square shapes, etc. Likewise, dipole arms may be formed in a wide variety of ways, including using sheet metal, on printed circuit boards, using choke structures, etc. Here, the dipole arms 80 are shown as being formed using a dipole radiator printed circuit board 82. The dipole arms 80 are shown as having cloaking structures (here a series of widened metal segments 84 that are interconnected by narrow inductive traces 86). It will be appreciated that the radiating elements according to embodiments of the present invention that have the feed stalk designs disclosed herein may have any appropriate dipole arm design, including dipole arms having any shape, that are formed, for example, in any of the ways discussed above, and may or may not have cloaking dipole arms.

The first dipole radiator 70-1 extends along a first axis and the second dipole radiator 70-2 extends along a second axis that is generally perpendicular to the first axis.

Dipole arms 80-1 and 80-2 of first dipole radiator 70-1 are center fed by the first RF transmission line structure 16-1 on the first feed stalk printed circuit board 20-1 and radiate together at a first polarization. In the depicted embodiment, the first dipole radiator 70-1 is designed to transmit and receive signals having a +45° polarization. Dipole arms 80-3 and 80-4 of second dipole radiator 70-2 are center fed by the second RF transmission line structure 16-2 on the second feed stalk printed circuit board 20-2 and radiate together at a second polarization that is orthogonal to the first polarization. The second dipole radiator 70-2 is designed to transmit and receive signals having a −45° polarization. The dipole arms 80 may be mounted approximately 3/16 to ¼ an operating wavelength forwardly of a reflector (not shown) of a base station antenna that includes radiating element 1.

FIG. 1B is a shadow side view of the conventional cross-dipole radiating element 1 of FIG. 1A that illustrates the metallization patterns on feed stalk printed circuit board 20-1 of feed stalk 10. In FIG. 1B, the solid lines are the metallization patterns on the first side of feed stalk printed circuit board 20-1 and the dashed lines are the metallization patterns on the second (opposed) side of feed stalk printed circuit board 20-1. In FIG. 1B, only a side surface of feed stalk printed circuit board 20-2 is visible as the major surfaces of feed stalk printed circuit board 20-2 are perpendicular to the viewing angle.

As shown in FIG. 1B, a twin line transmission line structure 30 is formed on the second side of feed stalk printed circuit board 20-1. The twin line transmission line structure 30 comprises first and second metallized regions 32-1, 32-2 that extend from the base 12 of feed stalk 10 to the distal end 14 thereof. Each metallized region 32-1, 32-2 is coupled to the ground conductor of the first feed transmission line for radiating element 1 (not shown). Herein, these metallized regions 32-1, 32-2 are also referred to as first and second ground lines 32-1, 32-2 to reflect this connection to ground. The connections between the metallized regions 32-1, 32-2 and the ground conductor of the first feed transmission line may be at the base 12 of feed stalk 10. Each of the first and second ground lines 32-1, 32-2 includes a respective inwardly extending protrusion 34-1, 34-2. These protrusions 34-1, 34-2 are positioned just above the slit 22-1, and a small gap 36 where no metallization is provided separates the two protrusions 34-1, 34-2. The first and second ground lines 32-1, 32-2 may each have an electrical length of about ¼ the center wavelength of radiating element 1.

A signal trace 40 is formed on the first side of feed stalk printed circuit board 20-1. The signal trace 40 is coupled to the signal conductor of the feed transmission line that feeds the feed stalk printed circuit board 20-1. The signal trace 40 extends forwardly from the base 12 of feed stalk 10 and travels about two-thirds of the way toward the distal end 14 of feed stalk 10. The signal trace 40 then goes through a first 90° turn to extend transversely across the first side of feed stalk printed circuit board 20-1. Finally, the signal trace 40 goes through a second 90° turn to extend rearwardly toward the base 12 of feed stalk 10.

The signal trace 40 includes a forwardly extending segment 42-1, a transversely extending segment 42-2, and a rearwardly extending segment 42-3. The forwardly extending segment 42-1 comprises a widened pad region 44 near the base 12 of feed stalk 10 and a narrow trace 46 that extends forwardly from the widened pad region 44. The forwardly extending segment 42-1 overlaps the first ground line 32-1. Herein, two elements on a printed circuit board (or an equivalent structure) “overlap” if an axis that is perpendicular to a major surface of the printed circuit board intersects both elements. The transversely extending segment 42-2 comprises a narrow trace 48 that extends from trace 46 to cross over the gap 36 between the first and second ground lines 32-1, 32-2. The transversely extending segment 42-2 overlaps portions of both the first ground line 32-1 and the second ground line 32-2. The rearwardly extending segment 42-3 comprises a narrow trace 50 that extends at a right angle from the end of trace 48 back toward the base 12 of feed stalk 10. The rearwardly extending segment 42-3 overlaps the second ground line 32-2.

While feed stalk printed circuit board 20-2 is mostly not visible in FIG. 1B, it will be almost identical to printed circuit board 20-1, with the differences being (1) the location of the slits 22-1, 22-2 and (2) on feed stalk printed circuit board 20-2 the transversely extending segment 42-2 is closer to the base 12 of feed stalk 10 to allow this segment to cross over an axis defined by the slit 22-2 in the forward portion of feed stalk printed circuit board 20-2.

The first feed stalk printed circuit board 20-1 may be used to feed the first dipole radiator 70-1 as follows. The first and second ground lines 32-1, 32-2 and the signal trace 40 form the RF transmission line feed structure 16-1. When an RF signal is injected onto the feed stalk printed circuit board 20-1 from the corresponding feed transmission line, the RF energy travels along a microstrip transmission line segment formed by the forwardly extending segment 42-1 and the transversely extending segment 42-2 running above the first ground line 32-1 to the gap 36 between the first and second ground lines 32-1, 32-2. The portion of the signal trace 40 that overlaps the second ground line 32-2 may, for example, have an electrical length of about ¼ the center wavelength (typically in the range of 0.2-0.35 the center wavelength) of radiating element 1 and is open-circuited. The gap 36 which acts as a balun to convert the unbalanced RF signals that travel along the microstrip transmission line formed by the forwardly extending segment 42-1 and the transversely extending segment 42-2 running above the first ground line 32-1 into a balanced RF signal that so that the first part of the balanced signal passes along the upper portion of ground line 32-1 to the first dipole arm 80-1 and the second part of the balanced signal passes along the upper portion of ground line 32-2 to the second dipole arm 80-2. In this fashion the RF transmission line structure 16-1 feeds the dipole arms 80-1, 80-2 with oppositely phased RF currents.

Balanced RF signals that flow along the feed stalk 10 generally do not radiate RF energy due to the balanced nature of the currents. However, if unbalanced RF currents are allowed to flow on the feed stalk 10, these currents will radiate RF energy, which is undesirable. In order to suppress such unbalanced RF currents, the twin ground lines 32-1, 32-2 are short-circuited to each other at the base 12 of the feed stalk 10 (typically by galvanically coupling both ground lines 32-1, 32-2 to a ground plane on the feedboard printed circuit board). As described above, each ground line 32-1, 32-2 may have a length of about ¼ the center wavelength. The short-circuit at the base of the twin ground lines 32-1, 32-2 will appear as an open-circuit one quarter of a wavelength away, which is at the distal end 14 of the feed stalk 10. This effective open-circuit operates to suppress unbalanced currents from flowing from the dipole arms 80-1, 80-2 onto the feed stalk 10, thus suppressing the emission of RF radiation from the feed stalk 10.

As the above discussion makes clear, the twin ground lines 32-1, 32-2 are short-circuited at the base of feed stalk 10 to suppress unbalanced currents from flowing from the dipole arms 80-1, 80-2 onto the feed stalk 10. The twin ground lines 32-1, 32-2, however, are large metal structures that each have a length of about ¼ the center wavelength of low-band radiating element 1. As such, the twin ground lines 32-1, 32-2 may each have a length of about ½ of a center wavelength of RF radiation emitted by nearby mid-band radiating elements, and hence any such mid-band RF radiation may induce mid-band currents on the twin ground lines 32-1, 32-2, which is undesirable.

Pursuant to embodiments of the present invention, cross-dipole radiating elements are provided that may have feed stalks that may have less effect on the radiation patterns of nearby higher frequency band radiating elements. The feed stalks used in the radiating elements according to embodiments of the present invention may exhibit improved cloaking performance because they may have less metal, because they have fewer ¼ wavelength metallized structures, because they have narrowed transmission lines that may exhibit increased inductance that may help suppress higher band currents from flowing on these structures, and/or may have filter structures that suppress the higher band currents. The improved cloaking performance may improve the peak directivity for the nearby higher frequency band radiating element (as compared to the same radiating element having a conventional feed stalk design)

The feed stalks included in some of the cross-dipole radiating elements according to embodiments of the present invention may have modified RF transmission line structures that do not include two full ¼ wavelength twin ground lines. For example, a single ¼ wavelength ground line may instead be provided which reduces the extent to which mid-band currents will form on the feed stalk. In addition, the width of the remaining ground line may be reduced to further reduce mid-band current formation. In addition, the feed stalks included in the cross-dipole radiating elements according to embodiments of the present invention may have short-circuited transmission lines that act to suppress unbalanced currents from flowing onto the feed stalk. At least a portion of the each short-circuited transmission line may be implemented as a microstrip transmission line, which shortens the physical length, reducing the amount of metal while still suppressing the unbalanced currents. These short-circuited transmission lines may also be implemented using very narrow, high inductance signal traces (as well as narrower ground lines) in order to help further suppress generation of mid-band currents on the low-band feed stalks. The feed stalks according to embodiments of the present invention may also be smaller, lower cost structures than conventional feed stalks.

Pursuant to some embodiments of the present invention, cross-dipole radiating elements are provided that include a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line, a first signal trace that at least partially overlaps the first ground line, and a transmission line segment that extends from the first ground line and/or the first signal trace, and the transmission line segment includes a transmission line signal trace that is short-circuited to a ground conductor of the transmission line segment.

Pursuant to other embodiments of the present invention, cross-dipole radiating elements are provided that include a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line that extends from the base to connect to the first dipole arm, a first signal trace that extends from the base to connect to the second dipole arm and a transmission line segment that has a transmission line signal trace that extends from the first signal trace.

Pursuant to still further embodiments of the present invention, cross-dipole radiating elements are provided that include a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line that extends from the base to connect to the first dipole arm, a second ground line that is separated from the first ground trace by a gap, a first signal trace that crosses the gap, and a transmission line segment that includes a transmission line signal trace that crosses the gap.

Pursuant to additional embodiments of the present invention, cross-dipole radiating elements are provided that include a feed stalk having a base and a distal end that is positioned forwardly of the base, a first dipole radiator mounted at the distal end of the feed stalk, the first dipole radiator including a first dipole arm and a second dipole arm, and a second dipole radiator mounted at the distal end of the feed stalk, the second dipole radiator including a third dipole arm and a fourth dipole arm. The feed stalk includes a first ground line and a first stub that extends from the first ground line that has a distal end that is open-circuited.

Pursuant to yet additional embodiments of the present invention, base station antennas are provided that include a first radiating element that is configured to operate in a first frequency band and a second radiating element that is configured to operate in a second frequency band that is lower than the first frequency band. The second radiating element comprises a feed stalk and at least one radiator mounted at a distal end of the feed stalk, the feed stalk including a first ground line that extends substantially from the base of the feed stalk to the distal end of the feed stalk, the first ground line including an interior opening that is completely enclosed by the first ground line, the interior opening forming a high pass filter that suppresses RF current in the first frequency band.

Pursuant to still other embodiments of the present invention, base station antennas are provided that include a first radiating element that is configured to operate in a first frequency band and a second radiating element that is configured to operate in a second frequency band that is lower than the first frequency band. The second radiating element comprises a feed stalk and at least one radiator mounted at a distal end of the feed stalk, the feed stalk including a first ground line that extends substantially from the base of the feed stalk to the distal end of the feed stalk, the first ground line including a plurality of slots formed therein that form a high pass filter that suppresses RF current in the first frequency band.

As noted above, the cross-dipole radiating elements according to embodiments of the present invention may have cloaking feed stalks that are more transparent to RF radiation emitted by nearby higher band radiating elements. The discussion of the cross-dipole radiating elements according to embodiments of the present invention below will focus on low-band radiating elements that are designed to be cloaking with respect to nearby mid-band radiating elements as an example. However, it will be appreciated that the techniques disclosed herein may be used, for example, to provide mid-band radiating elements that are cloaking with respect to nearby high-band radiating elements or in any other appropriate application.

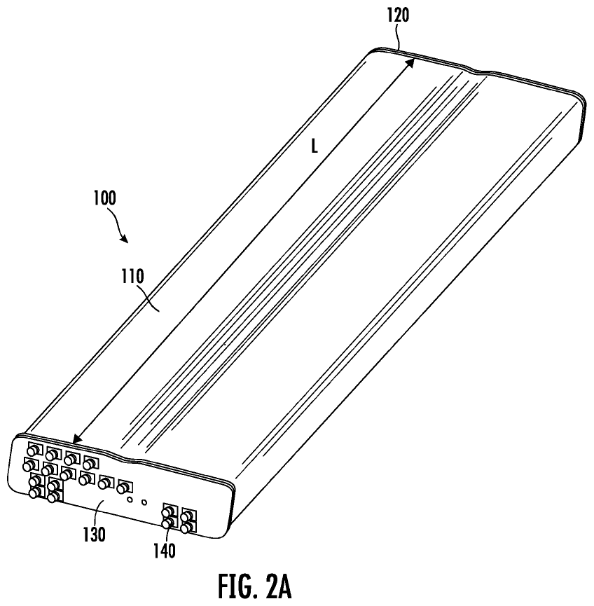

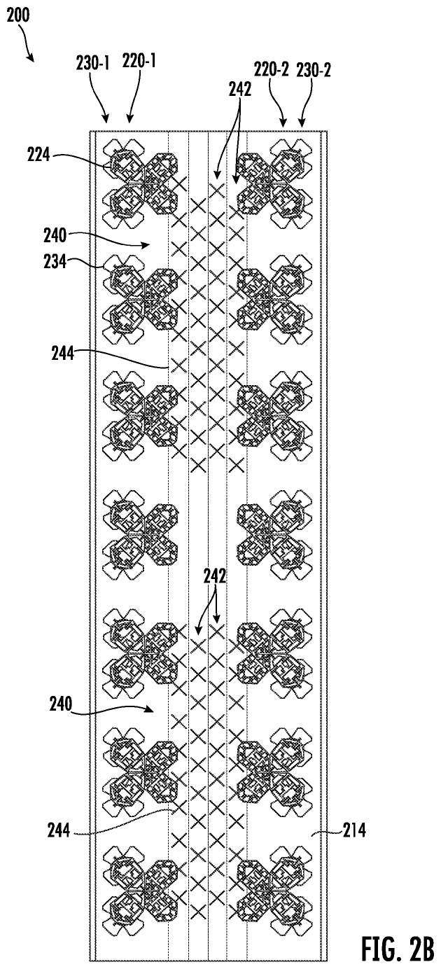

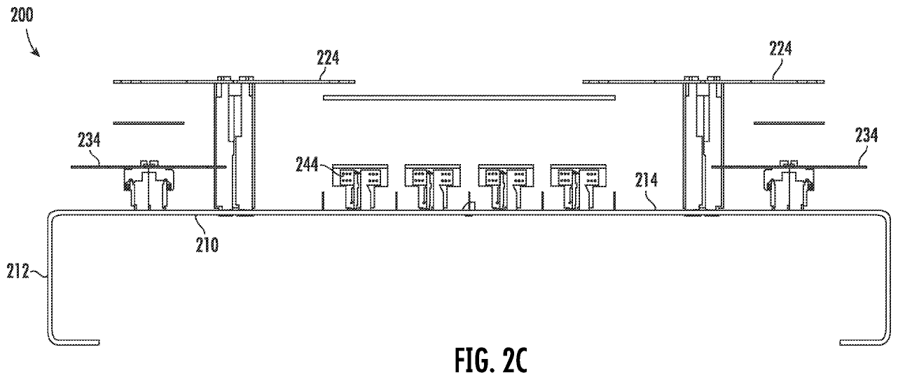

Embodiments of the present invention will now be described in further detail with reference to FIGS. 2A-9D.

FIGS. 2A-2C illustrate a base station antenna 100 that may include cross-dipole radiating elements according to embodiments of the present invention. In particular, FIG. 2A is a perspective view of the antenna 100, while FIG. 2B is a front view of the antenna 100 with the radome thereof removed to illustrate an antenna assembly 200 that is housed inside the radome. FIG. 2C is a schematic cross-sectional view of the antenna assembly 200 of FIG. 2B. In FIG. 2C the components of the antenna that are mounted behind the reflector 210 are omitted.

In the description that follows, the antenna 100 and the radiating elements included therein will be described using terms that assume that the antenna 100 is mounted for normal use on a tower with a longitudinal axis of the antenna 100 extending along a vertical axis and the front surface of the antenna 100 mounted opposite the tower pointing toward the coverage area for the antenna 100.

As shown in FIGS. 2A-2C, the base station antenna 100 is an elongated structure that extends along a longitudinal axis L. The base station antenna 100 may have a tubular shape with a generally rectangular cross-section. The antenna 100 includes a radome 110 and a top end cap 120. The antenna 100 also includes a bottom end cap 130 which includes a plurality of connectors 140 such as RF ports mounted therein. The antenna 100 is typically mounted in a vertical configuration (i.e., the longitudinal axis L may be generally perpendicular to a plane defined by the horizon) when the antenna 100 is mounted for normal operation. The radome 110, top cap 120 and bottom cap 130 may form an external housing for the antenna 100. An antenna assembly 200 is contained within the external housing. The antenna assembly 200 (FIGS. 2B-2C) may be slidably inserted into the radome 110 from either the top or bottom before the top cap 120 or bottom cap 130 are attached to the radome 110.

Referring now to FIGS. 2B and 2C, the antenna assembly 200 includes a ground plane structure 210 that has sidewalls 212 and a reflector surface or “reflector” 214. Various mechanical and electronic components of the antenna (not shown) may be mounted in a chamber that is defined between the sidewalls 212 and the back side of the reflector 214 such as, for example, phase shifters, remote electronic tilt units, mechanical linkages, controllers, diplexers, and the like. The reflector 214 of the ground plane structure 210 may comprise or include a metallic surface (e.g., a sheet of aluminium) that serves as a reflector and ground plane for the radiating elements of the antenna 100.

A plurality of dual-polarized radiating elements are mounted to extend forwardly from the reflector 214. The radiating elements include low-band radiating elements 224, mid-band radiating elements 234 and high-band radiating elements 244. The low-band radiating elements 224 are mounted in two columns to form two linear arrays 220-1, 220-2 of low-band radiating elements 224. The mid-band radiating elements 234 may likewise be mounted in two columns to form two linear arrays 230-1, 230-2 of mid-band radiating elements 234. Two planar arrays of high-band radiating elements 244 are included in base station antenna 100, each of which has four columns 242 of high-band radiating elements 244. Each planar array 240-1, 240-2 may be coupled to a respective beamforming radio (not shown), so that the planar arrays 240 may perform active beamforming to generate higher gain antenna beams. Herein, the linear arrays 220-1, 220-2 of low-band radiating elements 224 may also be referred to as the low-band linear arrays 220-1, 220-2, the linear arrays 230-1, 230-2 of mid-band radiating elements 234 may also be referred to as the mid-band linear arrays 230-1, 230-2, and the planar arrays 240 of high-band radiating elements 244 may be referred to as high-band arrays 240. It will also be appreciated that the number of arrays of low-band, mid-band and/or high-band radiating elements may be varied from what is shown in FIGS. 2B and 2C, as may the number of columns and/or radiating elements in each array, and the relative positions of the arrays. For example, the planar array 240 of high-band radiating elements 244 may be omitted in another example embodiment or replaced with additional mid-band linear arrays 230. The radiating elements according to embodiments of the invention may be used in arrays having any suitable configuration.

The low-band radiating elements 224 may be configured to transmit and receive signals in the 617-960 MHz frequency range or a portion thereof (e.g., the 617-896 MHz frequency band, the 696-960 MHz frequency band, etc.). The mid-band radiating elements 234 may be configured to transmit and receive signals in the 1427-2690 MHz frequency range or a portion thereof (e.g., the 1710-2200 MHz frequency band, the 2300-2690 MHz frequency band, etc.). The high-band radiating elements 244 may be configured to transmit and receive signals in the 3100-5800 MHz frequency range or a portion thereof.

The radiating elements 224, 234, 244 may be dual polarized radiating elements (e.g., −45°/+45° cross-dipole radiating elements), and hence each array 220, 230, 240 may be used to form a pair of antenna beams, namely an antenna beam for each of the two polarizations at which the dual-polarized radiating elements are designed to transmit and receive RF signals.

While not shown in the figures, the radiating elements 224, 234, 244 may be mounted on feed board printed circuit boards that couple RF signals to and from the individual radiating elements 224, 234, 244. One or more radiating elements 224, 234, 244 may be mounted on each feed board printed circuit board. Cables may be used to connect each feed board printed circuit board to other components of the antenna such as diplexers, phase shifters or the like.

The low-band radiating elements 224 may have dipole arms that are designed to be substantially transparent to RF energy emitted by the mid-band radiating elements 234. For example, the low-band radiating elements 224 may each have the cloaked dipole radiators 70-1, 70-2 discussed above with reference to FIG. 1A, although any cloaking design may be used. In addition, the low-band radiating elements 224 may have feed stalks that are designed to have improved transparency with respect to RF energy emitted by the mid-band radiating elements 234. As such, even if the mid-band radiating elements 234 are in close proximity to the low-band radiating elements 224, the above-discussed undesired coupling of mid-band RF energy onto the low-band radiating elements 224 may be significantly reduced. In the discussion that follows, example low-band radiating elements will be discussed that have such cloaked feed stalks. It will be appreciated that any of these radiating elements may be used to implement the low-band radiating elements 224 included in base station antenna 100. It will also be appreciated that these radiating elements may have any cloaked dipole radiator design, or may even have non-cloaked dipole arms. Thus, the discussion below will focus on the feed stalk design of these radiating elements. It will be assumed for purposes of the discussion below that each of the radiating elements are implemented using the dipole radiators 70-1, 70-2 discussed above.

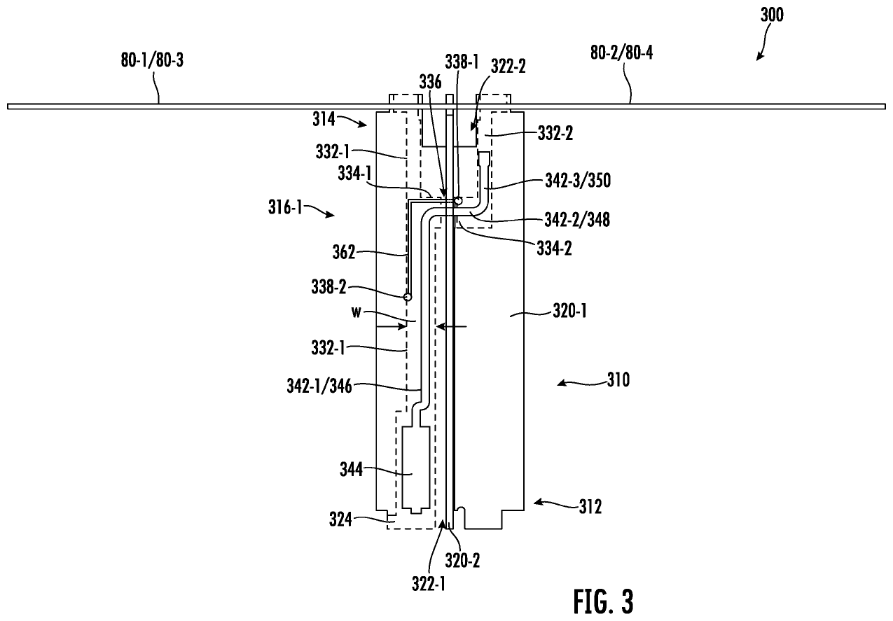

FIG. 3 is a side view of a low-band radiating element 300 according to embodiments of the present invention that may be used to implement the low-band radiating elements 224 of base station antenna 100. Low-band radiating element 300 includes a feed stalk 310 and a pair of dipole radiators 70-1, 70-2 that have dipole arms 80-1 through 80-4 (see FIGS. 1B and 2B). The dipole radiators 70-1, 70-2 have been discussed in detail above and hence the discussion of low-band radiating element 300 will focus on the feed stalk 310.

The feed stalk 310 has a base 312 and a distal end 314. The distal end 314 is positioned forwardly of the base 312. The feed stalk 310 comprises first and second feed stalk printed circuit boards 320-1, 320-2. Only a side surface of feed stalk printed circuit board 320-2 is visible in FIG. 3 as the major surfaces thereof are perpendicular to the viewing angle. Feed stalk printed circuit board 320-1 includes an RF transmission line structure 316-1 that carries RF signals between the feed transmission line (not shown) for feed stalk printed circuit board 320-1 and the cross-dipole radiator 70-1. The feed transmission line (not shown) may comprise, for example, a microstrip transmission line on a feed board printed circuit board that the radiating element 300 is mounted on, or a coaxial cable.

The first feed stalk printed circuit board 320-1 includes a slit 322-1 that extends forwardly from a base 312 of the feed stalk 310, and the second feed stalk printed circuit board 320-2 includes a slit 322-2 that extends rearwardly from the distal end 314 of the feed stalk 310. Feed stalk printed circuit boards 320-1 and 320-2 are arranged perpendicular to each other with the slit 322-2 in feed stalk printed circuit board 320-2 received within the slit 322-1 in feed stalk printed circuit board 320-1 so that the two mated printed circuit boards 310-1, 310-2 have a cross-shape when viewed from the front. The dipole radiators (see FIGS. 1B and 2B) of radiating element 300 are positioned adjacent the distal end 314 of the feed stalk 310 and may be (and typically are) physically mounted on the distal end of the feed stalk 310.

The base 312 of feed stalk printed circuit board 320-1 includes projections 324 that are inserted through slits in a feed board printed circuit board (not shown). A metallized pad on one of the projections 324 may be soldered to metallized pads on the feed board printed circuit board to mechanically mount the radiating element 300 on the feed board printed circuit board and to electrically connect the RF transmission line structures 316-1 on feed stalk printed circuit board 320-1 to the feed transmission line on the feed board printed circuit board.

The feed stalk printed circuit board 320-1 includes metallization patterns on each major surface thereof. In FIG. 3, the solid lines illustrate the metallization patterns on the first side of feed stalk printed circuit board 320-1, and the dashed lines illustrate the metallization patterns on the second side of feed stalk printed circuit board 320-1.

The second side of feed stalk printed circuit board 320-1 includes a metallized region 332-1 that extend from the base 312 of feed stalk 310 to the distal end 314 thereof. Metallized region 332-1 is similar to metallized region 32-1 of feed stalk printed circuit board 20-1 of FIG. 1B, but has a smaller width to reduce the total amount of metal. Feed stalk printed circuit board 320-1 also includes a metallized region 332-2 that extends from adjacent a protrusion 324-1 (discussed below) of metallized region 332-1 to the distal end 314 of the feed stalk 310. Metallized regions 332-1, 332-2 are also referred to as first and second ground lines 332-1, 332-2. Metallized region 332-1 is coupled to the ground conductor (not shown) of the first feed transmission line for radiating element 300 at the base 312 of feed stalk 310.

Each of the first and second ground lines 332-1, 332-2 includes a respective inwardly extending protrusion 334-1, 334-2. These protrusions 334-1, 334-2 are positioned just forwardly of the slit 322-1. A gap 336 where no metallization is formed separates the protrusions 334-1, 334-2. The first ground line 332-1 may has a length of about ¼ of the center wavelength of radiating element 300.

A signal trace 340 is formed on the first side of feed stalk printed circuit board 320-1. The signal trace 340 is coupled to the signal conductor of the feed transmission line that feeds feed stalk printed circuit board 320-1. The signal trace 340 extends forwardly from the base 312 of feed stalk 310 and travels about two-thirds of the way toward the distal end 314 of the feed stalk 310. The signal trace 340 then goes through a first 90° turn to extend transversely across the first side of feed stalk printed circuit board 320-1. Finally, the signal trace 340 goes through a second 90° turn to extend forwardly toward the distal end 314 of feed stalk 310.

The signal trace 340 includes a first forwardly extending segment 342-1, a transversely extending segment 342-2, and a second forwardly extending segment 342-3. The first forwardly extending segment 342-1 comprises a widened pad region 344 near the base 312 of feed stalk 310 and a narrow trace 346 that extends forwardly from the widened pad region 344. The first forwardly extending segment 342-1 overlaps the first ground line 332-1. The transversely extending segment 342-2 comprises a narrow trace 348 that extends from trace 346 to cross over the gap 336 between the first and second ground lines 332-1, 332-2. The transversely extending segment 342-2 overlaps portions of both the first ground line 332-1 and the second ground line 332-2. The second forwardly extending segment 342-3 comprises a narrow trace 350 that extends at a right angle from the end of trace 348 toward the distal end 314 of feed stalk 310. The second forwardly extending segment 342-3 overlaps the second ground line 332-2.

While feed stalk printed circuit board 320-2 is mostly not visible in FIG. 3, it will be almost identical to printed circuit board 320-1, with the differences being (1) the location of the slits 322-1, 322-2 and (2) on feed stalk printed circuit board 320-2 the transversely extending segment 342-2 is closer to the base 312 of the feed stalk 310 to allow this segment to cross over an axis defined by the slit 322-2 in the forward portion of feed stalk printed circuit board 320-2.

Feed stalk printed circuit board 320-2 further includes a transmission line segment 362. The transmission line segment 362 includes a narrow transmission line signal trace 364 that has a first end that overlaps the protrusion 334-2 of the second ground line 332-2, and a second end that overlaps the first ground line 332-2. A first plated through hole 338-1 galvanically connects the first end of transmission line signal trace 364 to the second ground line 332-2, and a second plated through hole 338-2 galvanically connects the second end of transmission line signal trace 364 to the first ground line 332-1. The transmission line signal trace 364 crosses over (overlaps) the gap 336 between the first and second ground lines 332-1, 332-2.

The feed stalk printed circuit board 320-1 may be used to feed the first and second dipole arms 80-1, 80-2 of cross-dipole radiating element 300 as follows. The first and second ground lines 332-1, 332-2 and the signal trace 340 form the RF transmission line structure 316-1. When an RF signal is injected onto feed stalk printed circuit board 320-1 from its associated feed transmission line, the RF energy travels along a microstrip transmission line segment formed by the forwardly extending segment 342-1 and the transversely extending segment 342-2 of the signal trace 340 and the first ground line 332-1 to the gap 336 between the first and second ground lines 332-1, 332-2. The distal end of the signal trace 340 is open-circuited, and the portion of the signal trace 340 that is to the right of the gap 336 may have an electrical length of about a ¼ of the center wavelength (typically in the range of 0.2-0.35 the center wavelength). The open circuit at the end of the signal trace 340 creates an effective short circuit at the gap 336 which acts as a balun to convert the unbalanced RF signals that travel along the microstrip transmission line formed by the forwardly extending segment 342-1 and the transversely extending segment 342-2 running above the first ground line 332-1 into a balanced RF signal that so that the first part of the balanced signal passes along the upper portion of ground line 332-1 to the first dipole arm 80-1 and the second part of the balanced signal passes along the upper portion of ground line 332-2 to the second dipole arm 80-2. In this fashion the RF transmission line structure 316-1 center feeds the dipole arms 80-1, 80-2 with oppositely phased RF currents.

Feed stalk 310 only includes a single ground line 332-1 that extends the full length of the feed stalk 310. As such, it is not possible to short circuit two ground lines together at the base 312 of the feed stalk 310 in order to create an open circuit at the distal end of the feed stalk that suppresses unbalanced currents from flowing onto the feed stalk 310, as was done in conventional radiating element 1. As discussed above, if unbalanced RF currents are allowed to flow on the feed stalk 310, these currents will radiate RF energy, which is undesirable. Feed stalk 310 thus includes a short-circuited transmission line 360 that extends from the distal end 314 of feed stalk 310 and that may have an electrical length of about ¼ the center wavelength of low-band radiating element 300. This short-circuited transmission line 360 may act to suppress the flow of unbalanced currents from the dipole arms 80-1, 80-2 onto the feed stalk 310.

The short-circuited transmission line 360 comprises the above-discussed short-circuited transmission line segment 362 and the upper portion of the second ground line 332-2 that extends forwardly of the transversely extending segment 342-2 of signal trace 340. In some embodiments, the electrical length of the short-circuited transmission line 360 may be about ¼ the center wavelength of radiating element 300 (i.e., the electrical distance from the plated through hole 338-2 that short-circuits transmission line signal trace 364 to the first ground line 332-1 to the distal end of ground line 332-2 may be about ¼ the center wavelength of radiating element 300. As such, the short-circuited transmission line 360 may appear as an open circuit at the distal end 314 of feed stalk 310 that suppresses unbalanced currents from flowing from the dipole arms 80-1, 80-2 onto the feed stalk 310, thereby suppressing the emission of RF radiation from the feed stalk 310. It will also be appreciated that in practice, the short-circuited transmission line 360 need not have an electrical length of exactly ¼ of the center wavelength to sufficiently suppress unbalanced currents from flowing onto the feed stalk 310. Thus, in practice, the length of the short-circuited transmission line 360 may be selected based on multiple factors, such as the suppression of unbalanced currents and optimizing the impedance matching of the feed stalk 310 to the dipole arms 80-1, 80-2.

As is known in the art, the electrical length of a microstrip transmission line is less than the physical length thereof. Thus, since part of the short-circuited transmission line 360 is implemented as a microstrip transmission line, the physical length of the short-circuited transmission line may be reduced as compared to the physical length of the twin ground lines 32-1, 32-2 included in the conventional feed stalk 10 that perform the same function as the short-circuited transmission line 360.

While the short-circuited transmission line segment 362 extends from the second ground line 332-2 across the gap 336 and then extends rearwardly, it will be appreciated that embodiments of the present invention are not limited thereto. For example, in other embodiments, the short-circuited transmission line 362 may extend from the second ground line 332-2 across the gap 336 and may then extend forwardly toward the dipole arms 80.

As noted above, the width “w” of the full length ground line 332-1 is reduced in feed stalk 310 as compared to conventional feed stalk 10. This reduced width may improve the cloaking performance. The ground line 332-1, however, may be maintained to have a width that is larger (e.g., at least 2-3 times wider) than the width of the signal trace 340 so that the microstrip feed line formed by the ground line 332-1 and signal trace 340 may have good transmission characteristics.

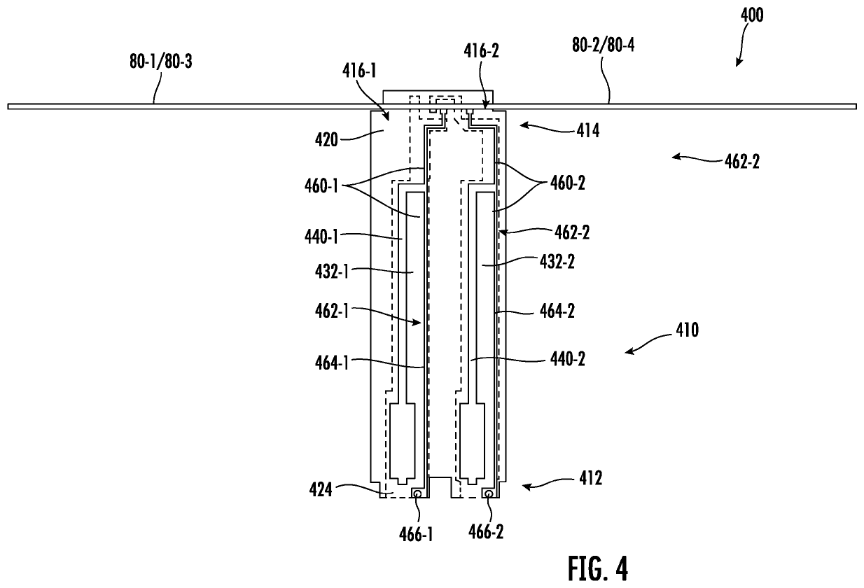

FIG. 4 is a side view of a low-band radiating element 400 according to further embodiments of the present invention that may be used to implement the low-band radiating elements 224 of base station antenna 100. Low-band radiating element 400 includes a feed stalk 410 and a pair of dipole radiators which may be implemented, for example, as the dipole radiators 70-1, 70-2 that are discussed in detail above with reference to FIG. 1A.

The feed stalk 410 has a base 412 and a distal end 414 that is positioned forwardly of the base 412. The feed stalk 410 comprises a single feed stalk printed circuit board 420 that has a pair of RF transmission line structures 416-1, 416-2 formed thereon that carry RF signals between the feed transmission lines (not shown) for the radiating element 400 and the cross-dipole radiators 70-1, 70-2 thereof. Both dipole radiators 70-1, 70-2 may be physically mounted on the distal end of the feed stalk printed circuit board 420. The base 412 of feed stalk printed circuit board 420 includes projections 424 that are inserted through slits in a feed board printed circuit board (not shown). Metallized pads on the projections 424 may be soldered to metallized pads on the feed board printed circuit board to mechanically mount the radiating element 400 on the feed board printed circuit board and to electrically connect the RF transmission line structures 416-1, 416-2 to the respective feed transmission lines on the feed board printed circuit board.

The feed stalk printed circuit board 420 includes metallization patterns on each major surface thereof. In FIG. 4, the solid lines illustrate the metallization patterns on the first side of feed stalk printed circuit board 410, and the dashed lines illustrate the metallization patterns on the second side of feed stalk printed circuit board 420

Feed stalk printed circuit board 420 includes first and second metallized ground lines 432-1, 432-2 that extend from the base 412 of feed stalk 410 to the distal end 414 thereof. Ground line 432-1 is coupled to the ground conductor (not shown) of the first feed transmission line for radiating element 400 and ground line 432-2 is coupled to the ground conductor (not shown) of the second feed transmission line for radiating element 400. Each ground line 432-1, 432-2 may have a length of about ¼ of the center wavelength of radiating element 400.

First and second signal traces 440-1, 440-2 are formed on feed stalk 420 and are coupled to the signal conductors (not shown) of the respective first and second feed transmission lines for radiating element 400. Each signal trace 440-1, 440-2 extends substantially the entire length of the feed stalk printed circuit board 420. The first signal trace 440-1 may overlap the first ground line 432-1 for substantially its entire length. The distal end of the first signal trace 440-1 is coupled to the first dipole arm 80-1 and the distal end of the first ground line 432-1 is coupled to the second dipole arm 80-2 so that the first signal trace 440-1 and the first ground line 432-1 form a first RF transmission line structure 416-1 that directly feeds the first dipole radiator 70-1. A second signal trace 440-2 that overlaps the second ground line 432-2 for substantially its entire length is also provided on feed stalk printed circuit board 420. The distal end of the second signal trace 440-2 is coupled to the third dipole arm 80-3 and the distal end of the second ground line 432-2 is coupled to the fourth dipole arm 80-4 so that the second signal trace 440-2 and the second ground line 432-2 form a second RF transmission line structure 416-2 that directly feeds the second dipole radiator 70-2.

Feed stalk printed circuit board 420 may be used to feed the first dipole radiator 70-1 as follows. The first signal trace 440-1 directly connects the signal conductor of the first feed transmission line to the first dipole arm 80-1. The first ground line 432-1 directly connects the ground conductor of the first feed transmission line to the second dipole arm 80-2. Similarly, the second signal trace 440-2 directly connects the signal conductor of the second feed transmission line to the third dipole arm 80-3. The second ground line 432-2 directly connects the ground conductor of the second feed transmission line to the fourth dipole arm 80-4. Here, a single feed stalk printed circuit board 420 is used to feed both dipole radiators 70-1, 70-2.

Feed stalk printed circuit board 420 further includes first and second transmission line segments 462-1, 462-2. Transmission line segment 462-1 comprises a microstrip transmission line that has a narrow transmission line signal trace 464-1 that extends from a central portion of the first signal trace 440-1 and that overlaps the first ground line 432-1. The end of the transmission line signal trace 464-1 adjacent the base 412 of the feed stalk 410 is short-circuited to the first ground line 432-1. The transmission line segment 462-1, along with the portions of the signal trace 440-1 and the first ground line 432-1, comprises a short-circuited transmission line 460-1 that extends from the distal end 414 of feed stalk 410 and that may have an electrical length of about ¼ the center wavelength of low-band radiating element 400. This short-circuited transmission line 460-1 may act to suppress the flow of unbalanced currents from the dipole arms 80-1, 80-2 onto the feed stalk 410. The width of the transmission line signal trace 464-1 is kept very narrow to increase the inductance thereof to facilitate further suppression of mid-band currents on feed stalk 410.

Similarly, transmission line segment 462-2 comprises a microstrip transmission line that has a narrow transmission line signal trace 464-2 that extends from a central portion of the second signal trace 440-2 and that overlaps the second ground line 432-2. The end of the transmission line signal trace 464-2 adjacent the base 412 of the feed stalk 410 is short-circuited to the second ground line 432-2. The transmission line segment 462-2, along with the portions of the signal trace 440-2 and the second ground line 432-2, comprises a short-circuited transmission line 460-2 that extends from the distal end 414 of feed stalk 410 and that may have an electrical length of about ¼ the center wavelength of low-band radiating element 400. This short-circuited transmission line 460-2 may act to suppress the flow of unbalanced currents from the dipole arms 80-3, 80-4 onto the feed stalk 410.

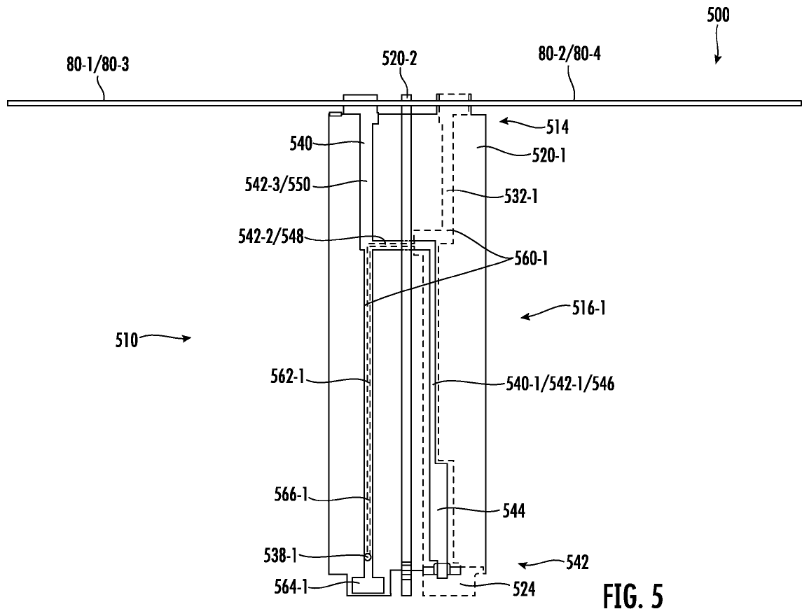

FIG. 5 is a side view of a low-band radiating element 500 according to still further embodiments of the present invention that may be used to implement the low-band radiating elements 224 of base station antenna 100. Low-band radiating element 500 includes a feed stalk 510 and a pair of dipole radiators which may be implemented, for example, as the dipole radiators 70-1, 70-2 that are discussed above.

The feed stalk 510 has a base 512 and a distal end 514 that is positioned forwardly of the base 512. The feed stalk 510 comprises first and second feed stalk printed circuit boards 520-1, 520-2. Only a side surface of feed stalk printed circuit board 520-2 is visible in FIG. 5 as the major surfaces thereof feed are perpendicular to the viewing angle. Each feed stalk printed circuit board 520-1, 520-2 includes a respective RF transmission line structure 516-1, 516-2 that carry RF signals between the feed transmission lines (not shown) for the radiating element 500 and the cross-dipole radiators 70-1, 70-2 thereof. The first and second feed stalk printed circuit boards 520-1, 520-1 are mated together in the same way, discussed above, that feed stalk printed circuit boards 320-1 and 320-2 are mated together. The dipole radiators 70-1, 70-2 may be physically mounted on the distal end of the feed stalk 510.

Feed stalk printed circuit board 520-1 includes metallization patterns on each major surface thereof. In FIG. 5, the solid lines illustrate the metallization patterns on the second side of feed stalk printed circuit board 520-1, and the dashed lines illustrate the metallization patterns on the first side of feed stalk printed circuit board 520-1.

As shown, the first side of feed stalk printed circuit board 520-1 includes a metallized ground line 532-1 that extends from the base 512 of feed stalk 510 to the distal end 514 thereof. Ground line 532-1 is coupled to the ground conductor (not shown) of the first feed transmission line for radiating element 500. Metallized region 532-1 is similar to metallized region 32-1 of feed stalk printed circuit board 20-1 of FIG. 1B, but has a smaller width to reduce the total amount of metal. The second side of feed stalk printed circuit board 520-1 includes a signal trace 540-1 that also extends from the base 512 of feed stalk 510 to the distal end 514 thereof. The signal trace 540-1 is coupled to the signal conductor of the feed transmission line that feeds feed stalk printed circuit board 520-1.

The signal trace 540-1 includes a first forwardly extending segment 542-1, a transversely extending segment 542-2, and a second forwardly extending segment 542-3. The first forwardly extending segment 542-1 comprises a widened pad region 544 near the base 512 of feed stalk 510 and a narrow trace 546 that extends forwardly from the widened pad region 544. The first forwardly extending segment 542-1 overlaps the first ground line 532-1. The transversely extending segment 542-2 comprises a narrow trace 548 that extends from trace 546. The second forwardly extending segment 542-3 comprises a narrow trace 550 that extends at a right angle from the end of trace 548 toward the distal end 514 of feed stalk 510. The distal end of the first signal trace 540-1 is coupled to the first dipole arm 80-1 and the distal end of the first ground line 532-1 is coupled to the second dipole arm 80-2 so that the first signal trace 540-1 and the first ground line 532-1 form a first RF transmission line structure 516-1 that directly feeds the first dipole radiator 70-1.

While feed stalk printed circuit board 520-2 is mostly not visible in FIG. 5, it will be almost identical to feed stalk printed circuit board 520-1, with the differences being (1) the location of the slits 522-1, 522-2 and (2) on feed stalk printed circuit board 520-2 the transversely extending segment 542-2 is closer to the base 512 of the feed stalk 510.

Feed stalk printed circuit board 520-1 may be used to feed the first dipole radiator 70-1 as follows. The first signal trace 540-1 directly connects the signal conductor of the first feed transmission line to the first dipole arm 80-1. The first ground line 532-1 directly connects the ground conductor of the first feed transmission line to the second dipole arm 80-2. Thus, the RF transmission line structure 516-1 directly feeds the first dipole radiator 70-1.

Feed stalk printed circuit board 520-1 further includes a transmission line segment 562. The transmission line segment 562-1 comprises a microstrip transmission line that has a narrow transmission line signal trace 564-1 that extends from a central portion of the first signal trace 540-1. The transmission line segment 562-1 further comprises a narrow ground trace 566-1 that extends from a central portion of the first ground line 532-1. The transmission line signal trace 564-1 overlaps the narrow ground trace 566-1. The end of the transmission line signal trace 564-1 that is adjacent the base 512 of the feed stalk 510 is short-circuited to the narrow ground trace 566-1 via a plated through hole 538-1 in Feed stalk printed circuit board 520-1. The transmission line segment 562 may along with the portions of the signal trace 540-1 and the first ground line 532-1 comprise a short-circuited transmission line 560-1 that extends from the distal end 514 of feed stalk 510 and that may have an electrical length of about ¼ the center wavelength of low-band radiating element 500. This short-circuited transmission line 560-1 may act to suppress the flow of unbalanced currents from the dipole arms 80-1, 80-2 onto the feed stalk 510. The width of the transmission line signal trace 564-1 is kept very narrow to increase the inductance thereof to facilitate further suppression of mid-band currents on feed stalk 510.

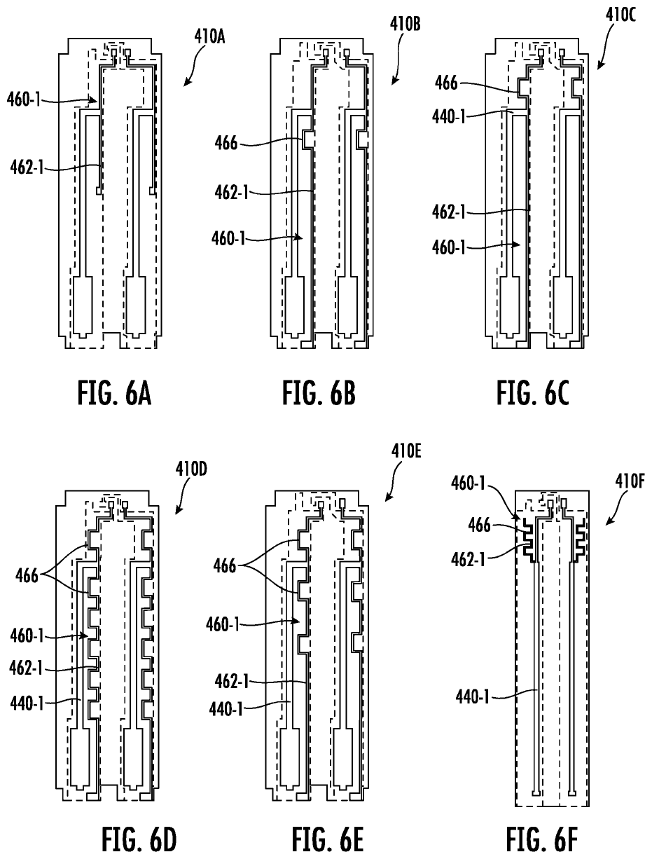

FIGS. 6A-6F are schematic shadow views of the first and second major surfaces of modified versions of the feed stalk printed circuit board 420-1 of FIG. 4 illustrating how the short-circuited transmission lines according to embodiments of the present invention may have different lengths. In the description of FIGS. 6A-6F below, only the first short-circuited transmission line 460-1 is discussed, but it will be appreciated that the feed stalks illustrated in FIGS. 6A-6F each include a second short-circuited transmission line 460-2 that has the same design as the first short-circuited transmission line 460-1 on each respective feed stalk.

As shown in FIG. 6A, in some embodiments, a feed stalk 410A may be provided where the transmission line segment 462-1 may be shortened from what is shown in FIG. 4. As described above, the electrical length of the short-circuited transmission line 460-1 may involve a tradeoff between impedance matching the RF transmission line structure 416-1 to the dipole arms 80-1, 80-2 and providing a short-circuited quarter wavelength transmission line stub that facilitates suppressing unbalanced currents flowing from the dipole arms 80-1, 80-2 onto the feed stalk 410. FIG. 6A shows that in some cases impedance matching concerns may result in a short-circuited transmission line 460-1 that may have an electrical length that is less than a ¼ of the center wavelength. In contrast, FIGS. 6B-6F depict feed stalks where the short-circuited transmission line 460-1 is lengthened from what is shown in FIG. 4 by meandering one or more sections of the transmission line 460-1. In FIG. 6B, the transmission line 460-1 is lengthened by providing a feed stalk 410B that has a transmission line segment 462-1 that includes a meandered segment 466. In FIG. 6C, the transmission line 460-1 is lengthened by providing a feed stalk 410C that has a meandered segment 466 in the forward portion of the signal trace 440-1. FIGS. 6D and 6E depict feed stalks 410D, 410E where the short-circuited transmission lines 460-1 are lengthened from what is shown in FIG. 4 by including multiple meandered segments 466 that are provided in the upper portions of the signal traces 440-1 and transmission line segments 462-1. Finally, FIG. 6F depicts a feed stalk 410F where the portion of short-circuited transmission line 460-1 that extends forwardly from the signal trace 440-1 is meandered by including multiple meandered segments 466 therein.

FIGS, 7A-7D are schematic shadow views of the first and second major surfaces of modified versions of the feed stalk 410 of FIG. 4 illustrating different connection schemes for connecting the feed stalk printed circuit board 420 to the dipole arms 80 (not shown).

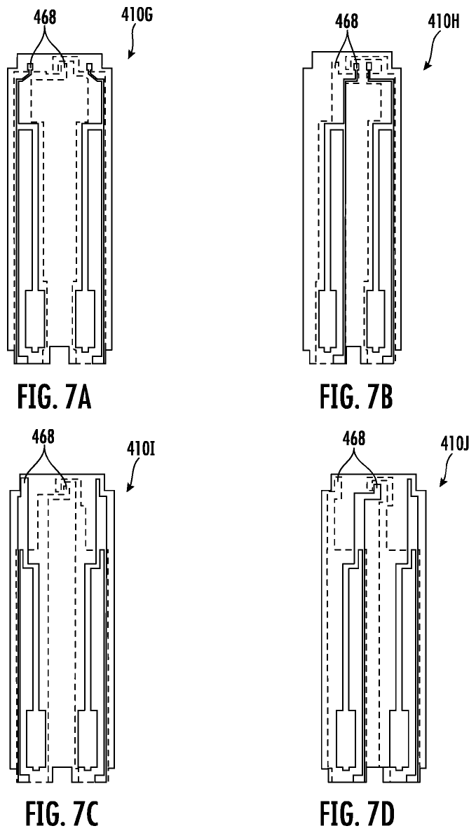

As shown in FIG. 7A, a feed stalk 410G has a similar design to feed stalk 410 but the connections 468 between the feed stalk 410G and the dipole arms 80 are spread farther apart than shown in FIG. 4. This may make it easier to form solder joints connecting the dipole arms 80 to the feed stalk 410G. FIGS. 7B-7D illustrate feed stalks 410H, 410I, 410J, respectively, that have slightly different connection 468 configurations.

FIG. 8 is a schematic shadow view of a cross-dipole radiating element 500A according to further embodiments of the present invention that is a modified version of radiating element 500 of FIG. 5. As can be seen by comparing FIGS. 5 and 8, radiating element 500A is very similar to radiating element 500, but includes a transmission line segment 562-1 that is meandered to have an increased electrical length. As described above, the transmission line segment 562-1 may be lengthened in order to improve the impedance match between the feed stalk 510A and the dipole arms 80-1, 80-2. In addition, the signal trace 540-1 and the first ground line 532-1 on feed stalk printed circuit board 520A-1 of radiating element 500A each include respective spurs that form an auxiliary microstrip stub 533-1. This auxiliary microstrip stub 533-1 acts as a low-pass filter to suppress higher frequency currents.

Pursuant to further embodiments of the present invention, radiating elements are provided that have feed stalks that include features that are designed to suppress higher frequency band current such as currents that would otherwise be induced on the ground lines in response to radiation emitted by nearby higher frequency band radiating elements.

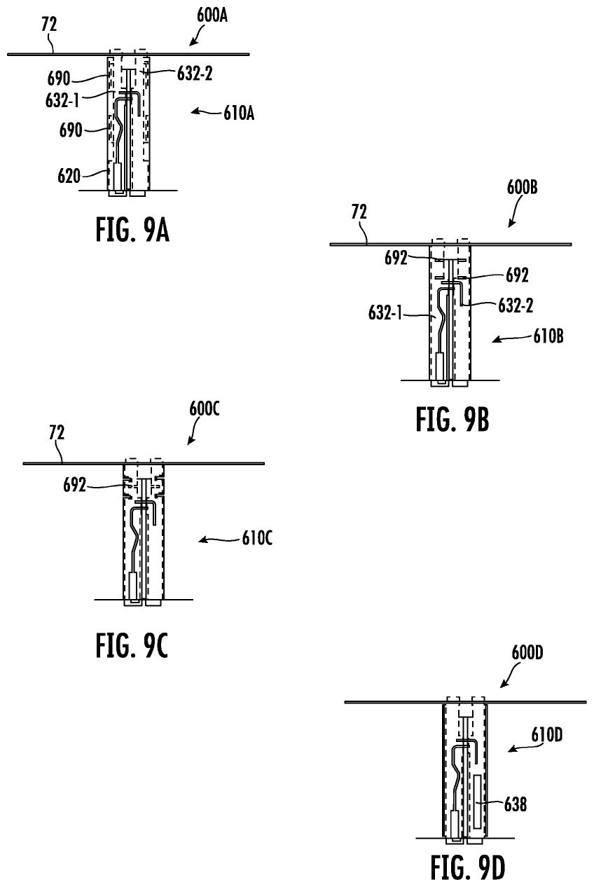

Example embodiments of such radiating elements 600A-600D are shown in FIGS. 9A-9D, respectively. The radiating elements shown in FIGS. 9A-9D may, for example, comprise the low-band radiating elements 224 of base station antenna 100, and the feed stalks thereof may be configured to suppress currents in the operating frequency bands of the mid-band radiating elements 234 and/or the high-band radiating elements 244. As another example, the radiating elements shown in FIGS. 9A-9D may comprise the mid-band radiating elements 234 of base station antenna 100, and the feed stalks thereof may be configured to suppress currents in the operating frequency band of the high-band radiating elements 244. Each of radiating elements 600A-600D includes a dipole radiator printed circuit board 72 includes a first dipole radiator 70-1 that has dipole arms 80-1, 80-2 and a second dipole radiator 70-2 that has dipole arms 80-3, 80-4. As dipole radiator printed circuit board 72 is discussed above with reference to FIGS. 1A-1B, further discussion of the dipole radiator printed circuit board 72 will be omitted in the discussion of FIGS. 9A-9D below.

Referring first to FIG. 9A, a radiating element 600A is shown that includes a feed stalk 610A and the dipole radiator printed circuit board 72. The feed stalk 610A may be very similar to the feed stalk 10 of conventional radiating element 1, but include ground lines 632-1, 632-2 that have forward portions that are narrower than the corresponding portions of the ground lines 32-1, 32-2 included on conventional the feed stalk 10. In addition, a plurality of narrowed stubs 690 extend from each ground line 632-1, 632-2, each of which has a distal end that is open-circuited. The electrical lengths of the stubs 690 may be selected so that the stubs function as a bandstop filter. In example embodiments, the electrical length of each stub may be between 0.2 and 0.3 of the center wavelength of a nearby radiating element in order to suppress currents forming on the feed stalk 610A in response to RF radiation emitted by such radiating element. While in the depicted embodiment, two stubs 690 extend from each ground line 632, embodiments of the present invention are not limited thereto. In other embodiments, fewer (1) or more (3, 4, 5 or more) stubs 690 may extend from each ground line 632. It will also be appreciated that the number of stubs 690 extending from each ground line 632 need not be the same. While the stubs 690 are shown as being formed on the same side of the feed stalk printed circuit board 620 as the ground lines 632, it will also be appreciated that some or all of the stubs 690 may be formed on the other side of the feed stalk printed circuit board 620, or that some or all of the stubs 690 can have portions on both sides of the feed stalk printed circuit board 620.

It will also be appreciated that the stubs 690 may be added to any of the feed stalks according to embodiments of the present invention that are discussed herein to further suppress formation of currents thereon in response to RF radiation emitted by nearby radiating elements. For example, the ground lines 332 on feed stalk 310, the ground lines 432 on feed stalk 410, and/or the ground lines 532 on feed stalk 510 may all include one or more of the stubs 690. Moreover, in some embodiments, the signal traces on these feed stalks may alternatively or similarly include stubs 690

Referring next to FIGS. 9B and 9C, radiating elements 600B and 600C are shown that each include a respective feed stalk 610B, 610C and the dipole radiator printed circuit board 72. The feed stalks 610B, 610C may be very similar to the feed stalk 10 of conventional radiating element 1, but include ground lines 632-1, 632-2 that have slots 692 (e.g., transversely-extending slots 692) formed therein where the metal of the ground lines 632 is removed or omitted. The slots 632 may be formed in a forward portion of the ground lines 632 that is forward of the signal trace 640. The number of slots 692 may be varied (e.g., 2, 3, 4, 5 or more per ground line 632). The slots 692 may effectively form one or more series inductances along the ground line 632 that suppress the formation of currents on the ground lines 632 in response to RF radiation emitted by nearby higher band radiating elements.

The lengths and/or widths of the slots 692 may be selected so that the slots function as a low-pass filter. The length of each slot 692 may represent a trade-off between better rejection of high-band currents forming on the feed stalks 610B, 610C in response to RF radiation emitted by such radiating element and poorer impedance matching in the lower frequency band. In the embodiment of FIG. 9B, three stubs 692 extend from each ground line 632, and slots 692 extend from each side of each ground line 632. Embodiments of the present invention are not limited thereto. In the embodiment of FIG. 9C, two stubs 692 extend from each ground line 632, and slots 692 extend from the inner side of each ground line 632. Many other configurations are possible having different numbers of slots, different arrangements of slots, different numbers of slots per ground line, etc.

It will also be appreciated that the slots 696 may be added to any of the feed stalks according to embodiments of the present invention that are discussed herein to further suppress formation of currents thereon in response to RF radiation emitted by nearby radiating elements. For example, the ground lines 332 on feed stalk 310, the ground lines 432 on feed stalk 410, and/or the ground lines 532 on feed stalk 510 may all include one or more of the slots 692.

Referring to FIG. 9D, a radiating element 600D is shown that includes a feed stalk 610D and the dipole radiator printed circuit board 72. The feed stalk 610D may be very similar to the feed stalk 10 of conventional radiating element 1, but the second ground line 632-2 has an interior opening 638 that is completely enclosed by the second ground line 632-2, the interior opening 638 forming a high pass filter that suppresses RF currents in the operating frequency band of a nearby higher frequency band radiating element (e.g., the high-band radiating elements 244 of base station antenna 100). The electrical length of the perimeter of the interior opening 638 may be selected so that the interior opening 638 function as a low-pass filter that will suppress RF currents in the operating frequency band of a nearby higher frequency band radiating element. In example embodiments, the electrical length of the opening may be about 0.2-0.3 of the center wavelength of a nearby radiating element in order to suppress currents forming on the feed stalk 610D in response to RF radiation emitted by such radiating element.

In some embodiments, the interior opening 638 may be located in a rearward portion of the second ground line 632-2. For example, the interior opening 638 may be located rearwardly of a transversely-extending segment of a signal trace 640 that is formed on the same feed stalk printed circuit board 620-1 as the second ground line 632-1. It will be appreciated, however, that the interior opening may be located in other positions. In some embodiments, the interior opening 638 may be a rectangular opening, but embodiments of the present invention are not limited thereto.

It will also be appreciated that the interior opening 638 may be added to any of the ground lines on the feed stalks according to embodiments of the present invention that are discussed herein to further suppress formation of currents thereon in response to RF radiation emitted by nearby radiating elements. For example, the ground lines 332 on feed stalk 310, the ground lines 432 on feed stalk 410, and/or the ground lines 532 on feed stalk 510 may all include an interior opening 638.

The radiating elements according to embodiments of the present invention may provide a number of advantages. First, as discussed above, the feed stalks of the radiating elements may exhibit better cloaking performance with respect to nearby higher band radiating elements. Additionally, the reduced metallization on the feed stalks allows for smaller feed stalk printed circuit boards to be used, which reduces the cost of the radiating elements.

While the dipole arms of the low-band radiating elements described above are implemented in dipole radiator printed circuit boards, it will be appreciated that embodiments of the present invention are not limited thereto. For example, in other embodiments, the dipole arms may be implemented as sheet metal dipole arms or using other metal structures.

While the feed stalks of the radiating elements according to embodiments of the present invention are illustrated as being implemented using feed stalk printed circuit boards, it will be appreciated that embodiments of the present invention are not limited thereto. In other embodiments, sheet metal feed stalks may be used instead (i.e., the same or similar structures as shown herein may be implemented using sheet metal (or other metal parts such as die cast metal parts).

Embodiments of the present invention have been described above with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms.

These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

Herein, the term “substantially” means within +/−10%.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed above can be combined in any way and/or combination with aspects or elements of other embodiments to provide a plurality of additional embodiments.

1. A cross-dipole radiating element, comprising:
a feed stalk having a base and a distal end that is positioned forwardly of the base;
a first dipole radiator mounted at the distal end of the feed stalk, the first dipole radiator including a first dipole arm and a second dipole arm; and
a second dipole radiator mounted at the distal end of the feed stalk, the second dipole radiator including a third dipole arm and a fourth dipole arm,
wherein the feed stalk includes a first ground line, a first signal trace that at least partially overlaps the first ground line, and a transmission line segment that extends from the first ground line and/or the first signal trace,
wherein the transmission line segment includes a transmission line signal trace that is short-circuited to a ground conductor of the transmission line segment.

2-3. (canceled)

4. The cross-dipole radiating element of claim 1, wherein the transmission line signal trace extends from the first signal trace.

5. The cross-dipole radiating element of claim 1, wherein the ground conductor of the transmission line segment extends from the first ground line.

6. (canceled)

7. The cross-dipole radiating element of claim 1, wherein the feed stalk comprises a feed stalk printed circuit board, and the first signal trace is a first metallization pattern on a first side of the feed stalk printed circuit board and the first ground line is a second metallization pattern on a second side of the feed stalk printed circuit board.

8. The cross-dipole radiating element of claim 7, wherein the feed stalk further comprises a second ground line that comprises a third metallization pattern on the second side of the feed stalk printed circuit board that is separated from the first ground line by a gap, and wherein the first signal trace and the transmission line signal trace each overlap the gap.

9. The cross-dipole radiating element of claim 8, wherein a first end of the transmission line signal trace is connected to the first ground line via a first plated through hole in the feed stalk printed circuit board and the second end of the transmission line signal trace is connected to the second ground line via a second plated through hole in the feed stalk printed circuit board.

10. (canceled)

11. The cross-dipole radiating element of claim 1, wherein the transmission line signal trace includes at least one meandered section.

12. (canceled)

13. The cross-dipole radiating element of claim 1, wherein the ground conductor of the transmission line segment has an average width that is less than an average width of the first ground line and the transmission line signal trace has an average width that is less than an average width of the first signal trace.

14-15. (canceled)

16. The cross-dipole radiating element of claim 1 in combination with a base station antenna that includes a second radiating element that is configured to operate in a second frequency band that is higher than an operating frequency band of the cross-dipole radiating element.

17. The cross-dipole radiating element of claim 16, wherein an open ended line that is configured to act as a bandpass filter that suppresses currents in the second frequency band extends from the first ground line.

18. The cross-dipole radiating element of claim 16, wherein a central region of the first ground line includes an open area where metallization is omitted that is configured to operate as a high-pass filter that suppresses currents in the second frequency band.

19. The cross-dipole radiating element of claim 16, wherein a forward portion of the first ground line includes a plurality of slots where metallization is omitted that are configured to suppress currents in the second frequency band.

20. A cross-dipole radiating element, comprising:
a feed stalk having a base and a distal end that is positioned forwardly of the base;
a first dipole radiator mounted at the distal end of the feed stalk, the first dipole radiator including a first dipole arm and a second dipole arm; and
a second dipole radiator mounted at the distal end of the feed stalk, the second dipole radiator including a third dipole arm and a fourth dipole arm,
wherein the feed stalk includes a first ground line that extends from the base to connect to the first dipole arm, a first signal trace that extends from the base to connect to the second dipole arm and a transmission line segment that has a transmission line signal trace that extends from the first signal trace.

21. The cross-dipole radiating element of claim 20, wherein the transmission line signal trace is short-circuited to the first ground line.

22-29. (canceled)

30. The cross-dipole radiating element of claim 20, wherein a width of the transmission line signal trace is less than a width of the first signal trace.

31-36. (canceled)

37. A cross-dipole radiating element, comprising:
a feed stalk having a base and a distal end that is positioned forwardly of the base;
a first dipole radiator mounted at the distal end of the feed stalk, the first dipole radiator including a first dipole arm and a second dipole arm; and
a second dipole radiator mounted at the distal end of the feed stalk, the second dipole radiator including a third dipole arm and a fourth dipole arm,
wherein the feed stalk includes a first ground line that extends from the base to connect to the first dipole arm, a second ground line that is separated from the first ground trace by a gap, a first signal trace that crosses the gap, and a transmission line segment that includes a transmission line signal trace that crosses the gap.

38. (canceled)

39. The cross-dipole radiating element of claim 37, wherein the first signal trace is short-circuited to the first ground line on a first side of the gap and is short-circuited to the second ground line on a second side of the gap.

40. The cross-dipole radiating element of claim 37, wherein the transmission line segment is at least a portion of a short-circuited transmission line that is configured to suppress unbalanced currents from flowing onto the feed stalk.

41. The cross-dipole radiating element of claim 37, wherein the transmission line segment is at least a portion of a short-circuited transmission line that has a base adjacent a distal end of the feed stalk, where the transmission line signal trace short-circuited to the ground conductor of the transmission line segment about a quarter wavelength of a center frequency of an operating frequency band of the cross-dipole radiating element away from the base of the short-circuited transmission line.

42. The cross-dipole radiating element of claim 37, wherein the first ground line acts as the ground conductor of the transmission line segment.

43-58. (canceled)
